(19) United States
(12) Patent Application Publication
(10) Pub. No.: US 2013/0112040 A1
(43) Pub. Date: May 9, 2013

(54) STEERING GEAR HOUSING FOR A STEERING UNIT IN A VEHICLE

(71) Applicant: Juergen Bieber, Pluederhausen (DE)

(72) Inventor: Juergen Bieber, Pluederhausen (DE)

(21) Appl. No.: 13/723,834

(22) Filed: Dec. 21, 2012

Related U.S. Application Data
(63) Continuation of application No. PCT/EP2011/059456, filed on Jun. 8, 2011.

(30) Foreign Application Priority Data
Jun. 30, 2010 (DE) 10 2010 030 737.8

(51) Int. Cl. F16H 57/025

(52) U.S. Cl. CPC F16H 57/025
USPC 74/606 R

(57) ABSTRACT

A steering housing for a steering unit in a vehicle has a housing tube for accommodating a linkage part, reinforcing struts being arranged at the exterior of the housing tube. Two reinforcing struts are respectively arranged adjacent to the two opposite ends of the housing tube and extend in different radial directions, wherein two reinforcing struts, respectively arranged at opposite ends of the housing tube are each bounded by one limiting plane, which lies at an angle to a tube axis through the housing tube.

This is a Continuation of PCT/EP2011/059456 Filed Jun. 8, 2011.

### BACKGROUND OF THE INVENTION

The invention relates to a steering gear housing for a steering unit in a vehicle.

Steering units for vehicles are known wherein, in order to assist steering, an electric servomotor is provided, which supplies an assisting torque via the steering gear of the steering unit. The steering gear with the steering linkage is accommodated in a steering housing, which is, for example, made of aluminum, in order to reduce the weight. For stability reasons, reinforcing ribs or struts may be arranged at the exterior of a housing tube of the steering housing, in which a linkage part is accommodated. In order to achieve safety-related prescribed stiffnesses and strengths for components, in general, the reinforcing struts are generously dimensioned; but this is detrimental in terms of the weight of the steering gear housing.

### SUMMARY OF THE INVENTION

It is therefore an object of the invention to develop a steering gear housing for a steering unit in a vehicle, having a simple construction, and having high stiffness and reduced weight

The inventive steering gear housing is a component of a steering unit in a vehicle, such as a passenger car or a commercial vehicle, and has at least one housing tube, which is intended to accommodate a linkage part. Reinforcing struts are provided at the exterior of the housing tube, which confer increased stiffness to the steering gear housing. Preferably, the steering gear housing is made from a light metal, such as aluminum or magnesium, and can be produced by injection molding. However, plastic housings with injection molded reinforcing ribs or struts of metal, and particularly of steel, are also contemplated.

According to the invention, two reinforcing struts are provided which, in relation to the linear housing tube, are respectively adjacent to the two opposite ends of the housing tube, extend in different radial directions, and have an increasing radial extension as the distance from the axial center of the tube increases. Two opposite reinforcing struts are respectively bounded by a common limiting plane, which passes through the housing tube at an angle, with respect to a central plane. At least two reinforcing struts, which are angularly offset with respect to one another, are arranged at each end of the tube, wherein two opposite reinforcing struts that are associated with each other are respectively bounded by a common limiting plane. Accordingly, at least two limiting planes exist, which, according to the invention, intersect at a location at the level of the housing tube.

The reinforcing struts, formed in this way, extend crosswise with respect to the housing tube, which results in a significant increase in stiffness, despite limited use of material. In each case, the two reinforcing struts at opposite ends of the housing tube lie crosswise, such that the point of intersection of the limiting planes is at the level of the housing tube. Here, the point of intersection is within the external periphery of the housing tube, for example, at least approximately in the radial center of the housing tube.

In accordance with a further suitable embodiment, four reinforcing struts, respectively extending in different radial directions, are arranged adjacent to the two opposite ends of the housing tube. In each case, the two opposite reinforcing struts are respectively arranged crosswise, bounded by a common limiting plane. Thus there is a total of at least eight reinforcing struts, wherein each of the two mutually opposite reinforcing struts are bounded respectively by a common limiting plane. Consequently, it is possible to define four limiting planes, wherein at least two limiting planes intersect at the level of the housing tube. Preferably, two of the four limiting planes respectively intersect at a point level with the housing tube, the intersecting points of the respective two limiting planes not necessarily coinciding with one another, even when this is possible.

By way of defining the limiting planes, an instrument is provided for designing the steering gear housing, allowing for high stiffness and strength in the steering housing, with minimal material costs.

It may be appropriate to arrange the reinforcing struts, which are bounded by a common limiting plane and arranged on opposite sides of the housing tube, offset to one another in the circumferential direction. In principle, however, it is sufficient to arrange the reinforcing struts at axially opposite ends, as well as on radially opposite sides, such that the planes, in which the two associated reinforcing struts lie, coincide. On the other hand, if the reinforcing struts are positioned offset in the circumferential direction, the planes resulting from the reinforcing struts are either parallel or enclose an angle.

In a preferred embodiment, the reinforcing struts are constructed at least approximately flat, but in principle curved or convexly or concavely arcuate variations of the embodiment are also contemplated. Moreover, it is possible to construct the reinforcing struts with a wall thickness that changes over the axial and/or radial extension of the struts. On the other hand, in accordance with a different embodiment, it is appropriate to provide a constant wall thickness either in the axial direction or in the radial direction or in both directions.

In order to minimize material use, it is advantageous if a central axial section of the housing tube is constructed either completely without reinforcing struts or formed in such a manner that the reinforcing struts are reduced to a minimum in this section. For example, the reinforcing struts or ribs may have a constant radial height in this section, which increases only in the transition to the reinforcing struts at the end.

In terms of the steering unit, in particular, a steering system with a servo support, driven by an electric motor, is contemplated. In principle, however, it is also possible to use the steering gear housing in steering systems with hydraulic servo support.

Moreover, it is possible to use the steering gear housing in an active steering system, in which an additional steering angle can be produced, which can be superimposed on the steering angle specified by the driver.

Further advantages and appropriate embodiments are given in the additional claims, the description of the figures and the drawings.

### BRIEF DESCRIPTION OF THE DRAWINGS

FIG. 1 shows a schematic representation of a steering unit in a vehicle;

FIG. 2 shows a steering gear housing of the steering unit in a side view;

FIG. 3 shows the steering gear housing in a representation rotated through 90°; and

FIGS. 4 to 6 show the steering gear housing in different perspective views.

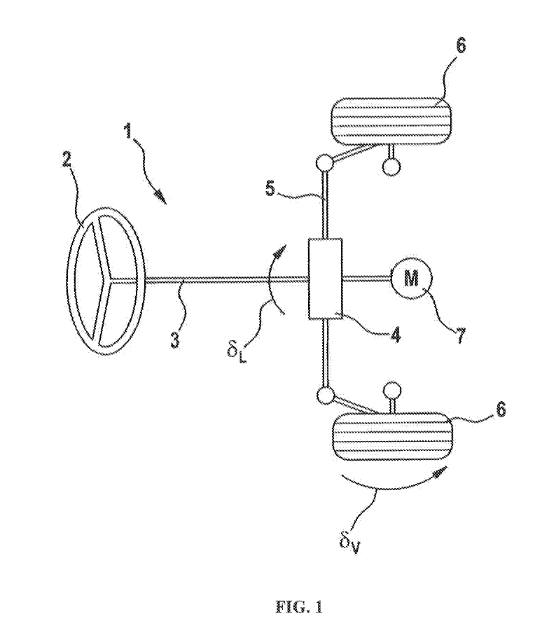

### DESCRIPTION OF THE PREFERRED EMBODIMENTS

In the Figures, identical components are given identical reference numbers.

The steering unit 1 comprises a steering wheel 2, a steering column or shaft 3, a steering housing 4 with a steering gear and a steering linkage 5 accommodated therein, by which a steering motion is transferred to the steerable wheels 6 of the vehicle. The driver specifies a steering angle δ_{L} via the steering wheel 2, to which the steering column 3 is firmly connected, and this is transferred by the steering gear in the steering housing 4 to a rack-and-pinion system of the steering linkage 5, whereupon the steerable wheels 6 are set at a steering angle δ_{V}.

In order to support the manual torque applied by the driver, an electric servomotor 7 is provided, by way of which an assistive servo-torque can be provided to the steering gear in the steering gear housing 4. Instead of an electric servomotor, a hydraulic assisting device may also be provided, such as a hydraulic pump, which is driven by a combustion engine and supplies a hydraulic steering system.

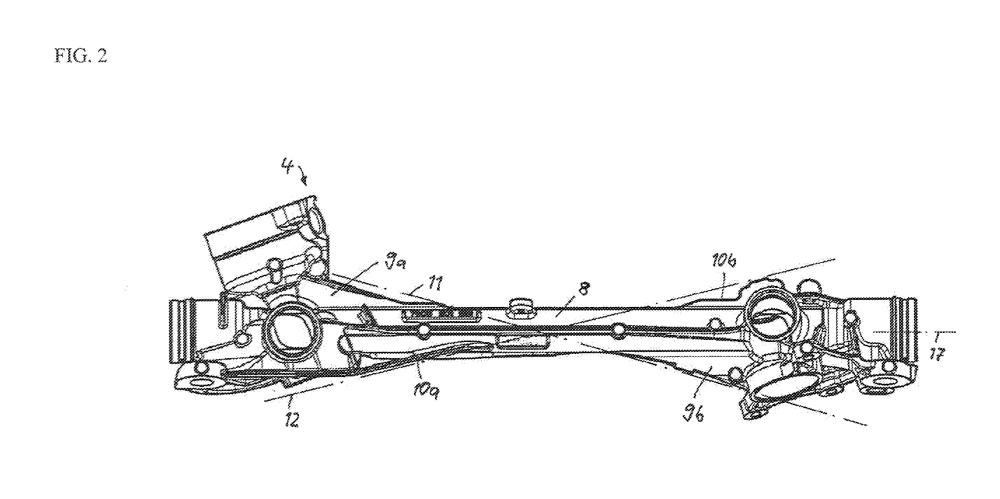

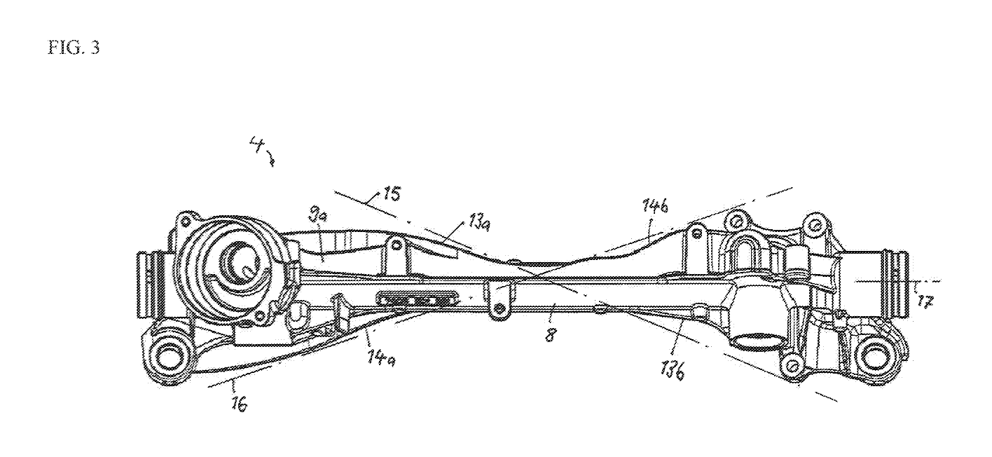

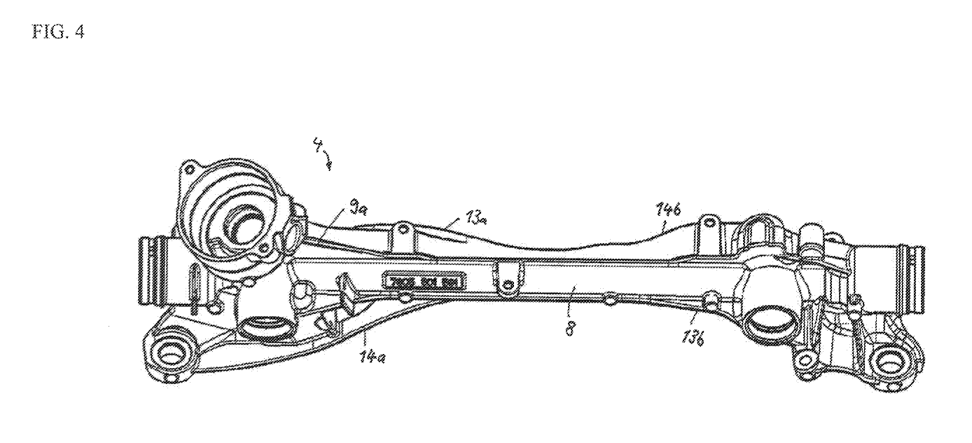

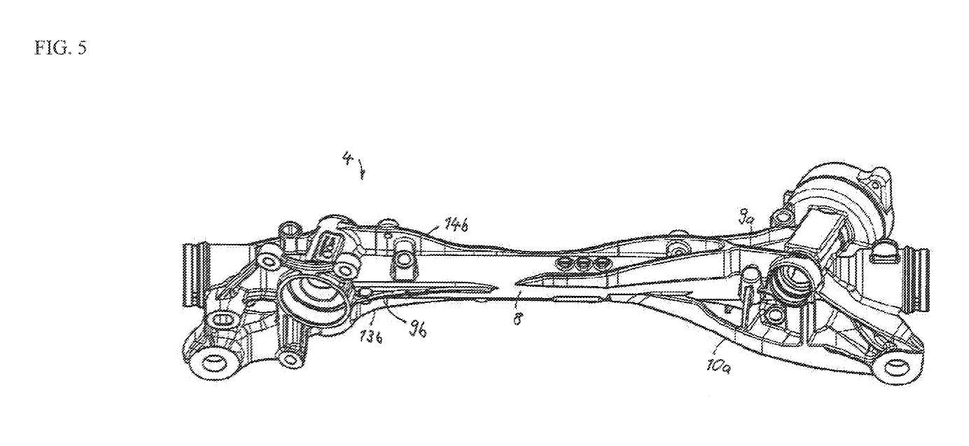

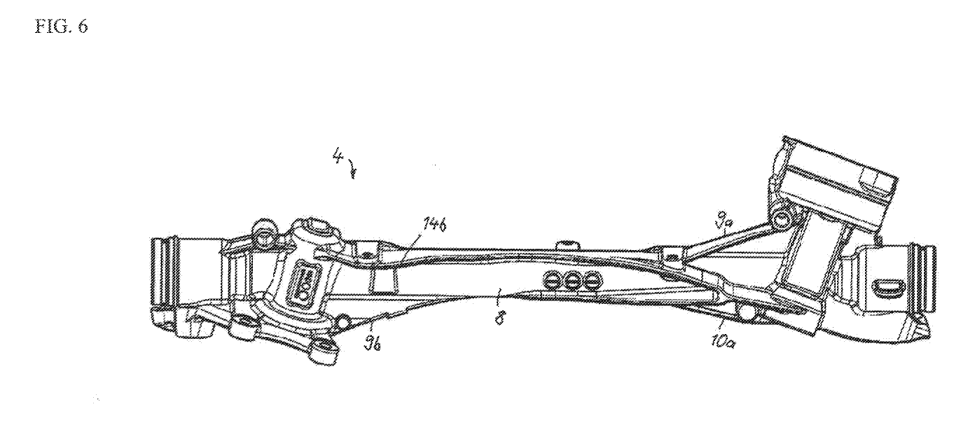

In FIGS. 2 to 6 below, the steering gear housing 4 is shown individually in various aspects. The steering gear housing 4 comprises a hollow cylindrical housing tube 8 serving to accommodate a linkage part of the steering linkage 5. The housing tube 8 of the steering gear housing 4, which is produced as an injection-molded aluminum part, has several reinforcing struts or ribs 9a, 9b, 10a, 10b, 13a, 13b, 14a and 14b, at the exterior, which are formed integrally with the housing tube 8 and the steering gear housing, to which they confer increased stiffness. The reinforcing struts are provided adjacent to the respective ends of the housing tube 8 but may be at an axial distance from the respective end faces of the housing tube 8. The radial extensions of the reinforcing struts vary over the axial lengths thereof, increasing in the direction of the end face of the housing tube. As can be seen, for example, from the reinforcing struts 9a, 10a (FIG. 2) or 14a, 13b (FIG. 3), the outer edge of the reinforcing struts may be linear. However, it is also possible to have a convexly or concavely curved outer edge, (reinforcing struts 13a, 14b, shown in FIG. 3) or an outer edge with alternating linear and curved sections, as shown, for example, for the reinforcing struts 9b, 10b in FIG. 2.

As can be inferred from the two views in FIGS. 2 and 3, which are rotated at an angle of 90° with respect to one another, four reinforcing struts 9a, 10a 13a, 14a or 9b, 10b, 13b, 14b are respectively provided at the two ends of the housing tube 8, the reinforcing struts at one end of the housing tube being offset by approximately 90° from one another. Each reinforcing strut in the region of a first end of the housing tube 8 is associated with an opposite or diagonally crosswise reinforcing strut in the region of the second end of the housing tube. This results in pairs of reinforcing struts 9a-9b, 10a-10b, 13a-13b and 14a-14b. The two respective reinforcing struts associated with one another in this manner are outwardly bounded by limiting planes 11, 12, 15 and 16. Thus, the limiting plane 11 is associated with the reinforcing struts 9a and 9b, the limiting plane 12 is associated with the reinforcing struts 10a and 10b, the limiting plane 15 is associated with the reinforcing struts 13a and 13b, and the limiting plane 16 is associated with the reinforcing struts 14a and 14b. Here, the limiting planes 11 and 12 (FIG. 2) delimit the reinforcing strut pairs 9a, 9b, 10a, 10b, the reinforcing struts 9a and 10a or 9b and 10b of which being arranged at one end of the housing tube 8, on opposite sides thereof. The same is true of the limiting planes 15 and 16, which delimit mutually opposite reinforcing struts 13a, 14a and 13b, 14b (FIG. 3) on respective sides of the housing tube 8.

Here, the two limiting planes 11 and 12 of the opposite reinforcing struts form a point of intersection, which lies within the border of the housing tube 8. Correspondingly, limiting planes 5 and 16, which are offset by 90° with respect to the limiting planes 11 and 12, form a point of intersection, which also lies within the border of the housing tube 8. In this context, the concept of “point of intersection” is to be understood in that the line of intersection, formed by the intersecting limiting planes, passes through the housing tube 8 in the transverse direction, and accordingly, a section of the line of intersection, comprising a series of points of intersection, is present within the housing tube 8.

The limiting planes enclose an angle with a tube axis 17 of the linearly constructed housing tube 8, which is at least approximately the same for all limiting planes 11, 12, 15, 16 and falls within an angular range of not more than 30° and more particularly of approximately 20°. The point of intersection, or line of intersection, of two respectively mutually intersecting limiting planes 11, 12 or 15, 16 lies, at least approximately, on the axis 17 of the tube 8 or may optionally be shifted slightly radially with respect to the axis 17 of the tube 8, as shown in FIG. 3.

### LIST OF REFERENCE SYMBOLS

1 steering unit

2 steering wheel

3 steering shaft

4 steering gear housing

5 steering linkage

6 front wheel

7 electric servomotor

8 housing tube

9a, 9b reinforcing struts

10a, 10b reinforcing struts

11 limiting plane

12 limiting plane

13a, 13b reinforcing struts

14a, 14b reinforcing struts

15 limiting plane

16 limiting plane

17 tube axis

1. A steering gear housing for a steering unit in a vehicle comprising a housing tube for accommodating a linkage part and having reinforcing struts at the exterior of the housing tube wherein, adjacent to the two opposite ends of the housing tube, at least two reinforcing struts extending in different radial directions, are respectively arranged, and at least two reinforcing struts, respectively arranged at opposite ends of the housing tube, are each bounded by one limiting plane lying at an angle with respect to a tube axis through the housing tube, wherein at least two limiting planes intersect at the level of the housing tube.

2. The steering gear housing according to claim 1, wherein adjacent to the two opposite ends of the housing tube, four reinforcing struts, respectively extend in different radial directions, are arranged, and two opposite reinforcing struts are respectively bounded by a common limiting plane.

3. The steering gear housing according to claim 1, wherein the reinforcing struts bounded by a common limiting plane, arranged on opposite sides of the housing tube, are arranged offset to one another in the circumferential direction.

4. The steering gear housing according to claim 1, wherein the reinforcing struts have a wall thickness that varies over the lengths thereof.

5. The steering gear housing according to claim 1, wherein the reinforcing struts are constructed at least approximately flat.

6. The steering housing according to claim 5, wherein the mutually opposite reinforcing struts, bounded by a common limiting plane, lie in parallel planes.

7. The steering gear housing according to claim 1, is constructed of a light metal, and particularly of aluminum.

8. The steering gear housing according to claim 1, wherein the reinforcing struts are reduced to a minimum in a central section of the housing tube.

9. The steering gear housing according to claim 1, wherein the reinforcing struts have a greater radial extension as the distance from the axial center of the tube increases.

10. A steering unit having a steering gear housing according to claim 1.
